(19) United States
(12) Patent Application Publication
(10) Pub. No.: US 2026/0262121 A1
(43) Pub. Date: Sep. 3, 2026

(54) DOWNLINK DATA HANDLING IN SEAMLESS ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/449,353

(22) Filed: Jan. 14, 2026

Related U.S. Application Data
(60) Provisional application No. 63/753,044, filed on Feb. 3, 2025.
(60) Provisional application No. 63/802,260, filed on May 8, 2025.
(60) Provisional application No. 63/921,793, filed on Nov. 20, 2025.

(51) Int. Cl. H04W 76/15; H04W 36/02

(52) U.S. Cl. CPC H04W 76/15; H04W 36/023

(57) ABSTRACT

Downlink (DL) data handling in seamless roaming in wireless local areas (WLANs). A method performed by a current access point (AP) multi-link device (MLD) includes identifying, from a plurality of options for handling of buffered frames at the current AP MLD for a non-AP MLD to roam from the current AP MLD to a target AP MLD, one or more of the options that are available for handling of the buffered frames and transmitting, to the non-AP MLD via a management frame, information indicating the one or more options that are available.

### CROSS-REFERENCE TO RELATED APPLICATION(S) AND CLAIM OF PRIORITY

This application claims priority under 35 U.S.C. § 119(e) to U.S. Provisional Patent Application No. 63/753,044 filed on Feb. 3, 2025; U.S. Provisional Patent Application No. 63/802,260 filed on May 8, 2025; and U.S. Provisional Patent Application No. 63/921,793 filed on Nov. 20, 2025. The above-identified provisional patent applications are hereby incorporated by reference in their entirety.

### TECHNICAL FIELD

This disclosure relates generally to wireless networks. More specifically, this disclosure relates to downlink (DL) data handling in seamless roaming in wireless local areas (WLANs) including next generation WLANs.

### BACKGROUND

WLAN technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for DL data handling in seamless roaming in WLANs.

In one embodiment, a method performed by a current access point (AP) multi-link device (MLD) is provided. The method includes identifying, from a plurality of options for handling of buffered frames at the current AP MLD for a non-AP MLD to roam from the current AP MLD to a target AP MLD, one or more of the options that are available for handling of the buffered frames and transmitting, to the non-AP MLD via a management frame, information indicating the one or more options that are available.

In another embodiment, a method performed by a non-AP MLD is provided. The method includes receiving, from a current AP MLD via a management frame, information indicating one or more options that are available, from a plurality of options for handling of buffered frames at the current AP MLD, for handling of the buffered frames of the non-AP MLD and determining, based on the received information, an option for handling of the buffered frames for the non-AP MLD to roam from the current AP MLD to a target AP MLD.

In yet another embodiment, an electronic device is provided. The electronic device includes at least one processor including processing circuitry and memory storing instructions. The instructions, when executed by the at least one processor individually or collectively, cause the electronic device to identify, from a plurality of options for handling of buffered frames at a current AP MLD for a non-AP MLD to roam from the current AP MLD to a target AP MLD, one or more of the options that are available for handling of the buffered frames and transmit, to the non-AP MLD via a management frame, information indicating the one or more options that are available.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of advertisement via beacons according to embodiments of the present disclosure;

FIG. 4 illustrates an example procedure for AP advertisement of available options during the preparation phase according to embodiments of the present disclosure;

FIG. 5 illustrates an example procedure for an AP side option selection according to embodiments of the present disclosure;

FIG. 6 illustrates an example of advertisement via beacons according to embodiments of the present disclosure;

FIG. 7 illustrates an example procedure for a STA side option selection according to embodiments of the present disclosure;

FIG. 8 illustrates an example procedure for STA side option selection with the current AP informed via the target AP according to embodiments of the present disclosure;

FIGS. 9A-9D illustrate examples of option indications/selections according to embodiments of the present disclosure;

FIG. 9E illustrates an example format of a per-transmit identifier (TID) info field for the indication of the status of the downlink transmission buffers according to embodiments of the present disclosure;

FIG. 10 illustrates an example procedure for advertisement and handling of buffered DL data frames of an non-AP MLD for a roam from a current AP MLD to a target AP MLD according to embodiments of the present disclosure;

FIG. 11 illustrates an example procedure handling of buffered DL data frames of an non-AP MLD for a roam from a current AP MLD to a target AP MLD according to embodiments of the present disclosure; and

FIG. 12 illustrates an example method performed by an AP MLD in a wireless communication system according to embodiments of the present disclosure.

### DETAILED DESCRIPTION

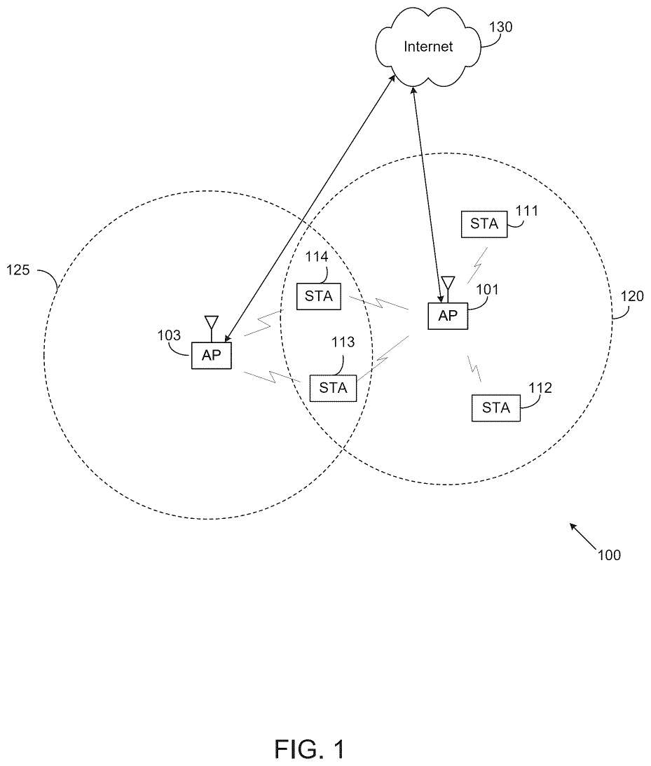

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MHLO). Devices capable of such MLO are referred to as multi-link devices (MLDs).

The following documents and standards descriptions are hereby incorporated into the present disclosure as if fully set forth herein: [1] IEEE P802.11be/D7.0, 2024; and [2] IEEE Std 802.11-2020.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for DL data handling in seamless roaming in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

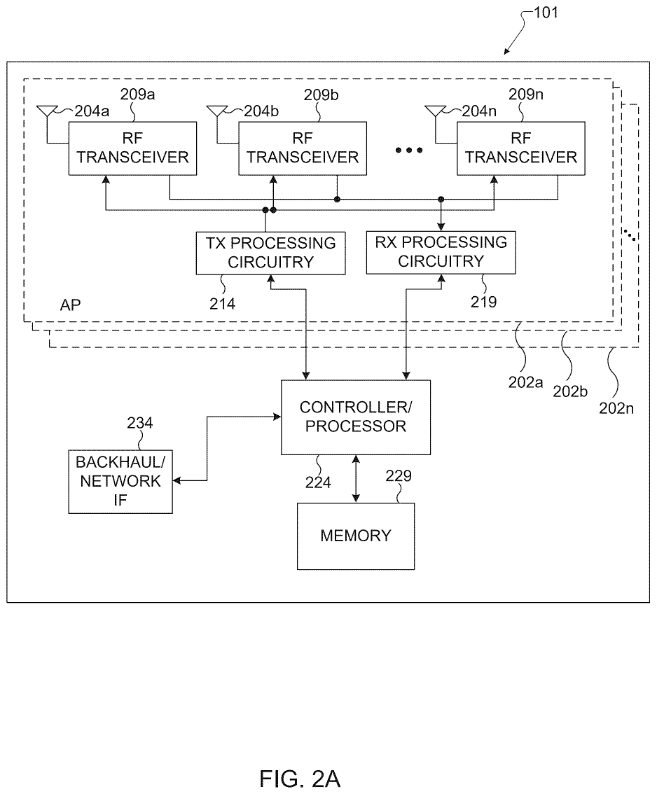

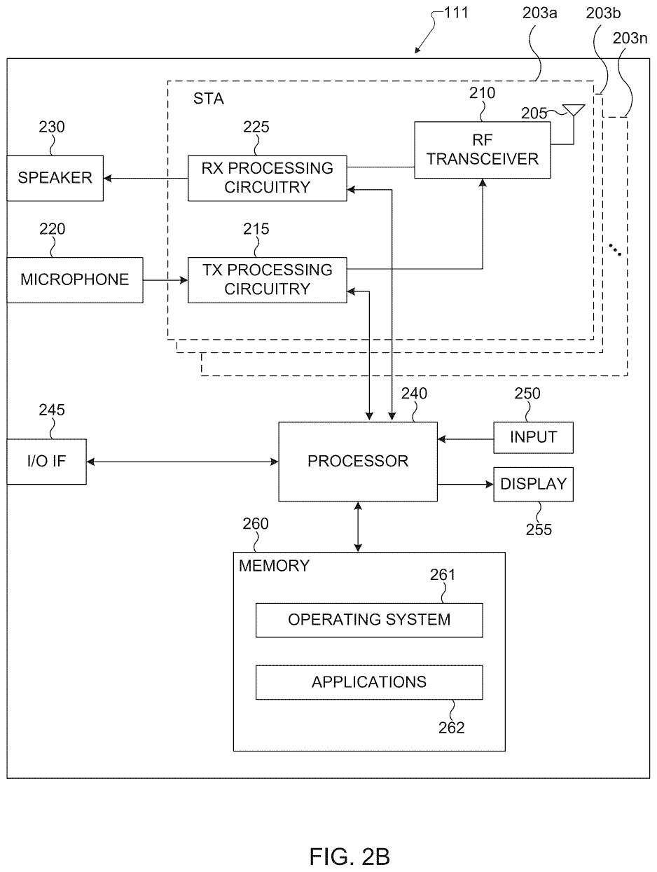

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for DL data handling in seamless roaming in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate DL data handling in seamless roaming in WLANs. In some embodiments, the processor 240 includes at least one microprocessor or microcontroller.

The processor 240 is also capable of executing other processes and programs resident in the memory 260, such as operations for DL data handling in seamless roaming in WLANs. The processor 240 can move data into or out of the memory 260 as required by an executing process. In some embodiments, the processor 240 is configured to execute a plurality of applications 262, such as applications for DL data handling in seamless roaming in WLANs. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Seamless roaming in WLANs is a roaming procedure for a non-AP MLD (e.g., STA 111) to transition from a current AP MLD (e.g., AP 101) to a target AP MLD (e.g., AP 103) with a goal such that the time during which the connection is lost is minimal. The seamless roaming procedure can enable a non-AP MLD to remain in state 4 of association while transitioning from current AP MLD to target AP MILD.

The roaming procedure can include multiple stages. Two of the important stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from current AP MLD to target AP MLD. The current AP MLD can process the request frame and send a response frame to the non-AP MLD after the transfer of context is complete. These procedures can enable the non-AP MLD to seamlessly roam from current to target AP MLD.

Embodiments of the present disclosure recognize that the non-AP MLD, which can include one or more non-AP STAs affiliated with it, can be capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD BSS transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further an AP MLD can use the BTM framework to recommend one or more candidate target AP MILDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MILD.

When the non-AP MLD uses SMD BSS transition to transition from an AP MLD (referred to as the current AP MLD without loss of generality) to another AP MLD within the same SMD (referred to as the target AP MILD), the non-AP MLD can perform an SMD BSS transition preparation procedure. The preparation procedure can be performed in advance before the transition occurs. The preparation procedure can be performed by transmitting a preparation request frame to the current AP MILD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MILD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MILD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MILD. The target AP MLD can transmit an execution response frame to the non-AP MLD.

When a non-AP MLD performs execution/transition procedure to roam from the current AP MLD to the target AP MLD, the downlink data of the non-AP MLD that is already buffered at the current AP MLD or can arrive at the current AP MLD after the non-AP MLD transmits a roam request message to the current AP MLD needs to be handled. The current AP MLD needs to know how to handle this buffered data.

Accordingly, various embodiments of the present disclosure provide a number of solutions for handling the buffered data at the current AP MLD after roam transition/execution procedure is started. These solutions include, but are not limited to, advertisement of AP side options advertisement, an AP side option selection, a STA side option selection, a multiple option selection, and signaling associated therewith. These solutions include, but are not limited to, a capability indication, a buffer size indication, and operations associated therewith.

Various embodiments provide for advertisement of AP side options. According to one embodiment, the current AP MLD can perform a number of operations on the buffered frames. Examples can be as listed in Table 1.

TABLE 1
Examples of operations that can be
performed by the current AP MLD

| Operation | Example description |
|---|---|
| Forward | The current AP MLD can forward the buffered |
| frames | frames to another AP MLD such as the target |
| | AP MLD. |
| Drop frames | The current AP MLD can drop the frames. |
| Buffer | The current AP MLD can buffer the frames and |
| frames | transmit to the non-AP MLD. |

According to one embodiment, the current AP MLD can have the same option for all the different types of frames, e.g., same option for all the transmit identifiers (TIDs). In other words, all TIDs are handled the same way.

According to another embodiment, the current AP MLD can have different options for different types of frames, e.g., forward/buffer frames that correspond to low latency TIDs and drop the remaining. Here, different TIDs can be handled according to different options.

The above information can be carried in an SMD information element. There can be a one bit indication in the SMD information element that can be set to 1 if an operation mentioned above can be supported by the SMD and to 0 if an operation mentioned above cannot be supported by the SMD. For instance, there can be a bit to indicate if downlink (DL) data forwarding i.e., the forwarding of buffered downlink data of a non-AP MLD from the current AP MLD to a target AP MLD can be supported by the SMD. The bit can be set to 1 to make the indication and to 0 to indicate otherwise.

The SMD information element can be advertised in management frames such as beacons, probe responses, (re)association responses, etc.

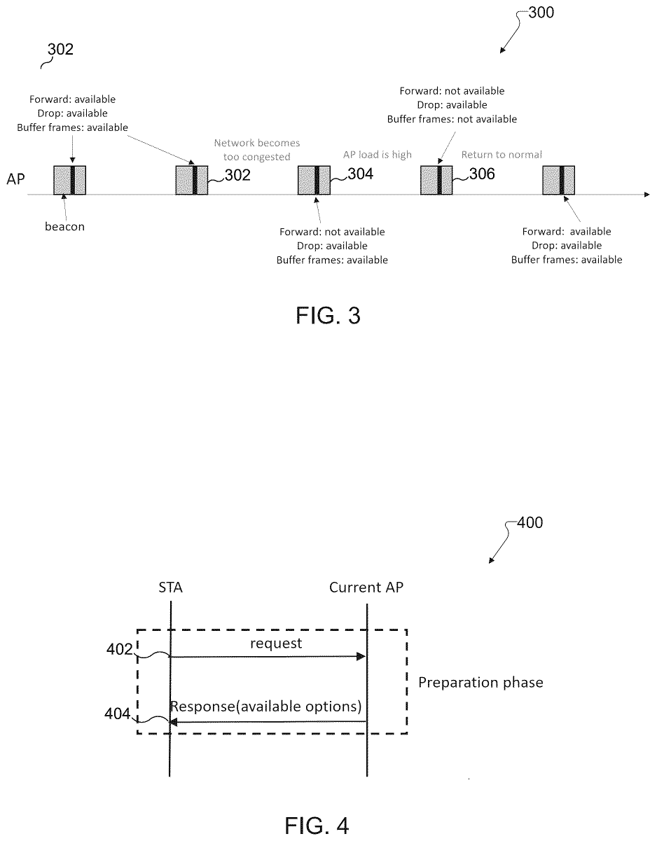

FIG. 3 illustrates an example of advertisement via beacons 300 according to embodiments of the present disclosure. The embodiment of the example of using beacons 300 for advertisement shown in FIG. 3 is for illustration only. Other embodiments could be used without departing from the scope of this disclosure.

According to one embodiment, the AP can advertise these options in beacons as illustrated in FIG. 3. For example, the AP may advertise, in beacon 302, to the STA that forwarding, dropping and buffering of the frames is available. The options can change over time based on network and traffic scenarios. In one example, if the network side load increases, forwarding frames may not be a good or available option. In this case, the AP may disable this option, for example, by changing the advertisement, in beacon 304, to only indicate that dropping or buffering of the buffered frames is available. In another example, if the AP side load increases, the AP may disable the option to buffer frames, for example, by changing the advertisement, in beacon 306, to only indicate that dropping the buffered frames is available.

FIG. 4 illustrates an example procedure 400 for AP advertisement of available options during the preparation phase according to embodiments of the present disclosure. For example, the procedure 400 of FIG. 4 can be performed between any of the STAs 111-114 of FIG. 1, such as the AP MLD 111 of FIG. 3 and any of the APs 101-103 of FIG. 1, such as AP MLD 101 of FIG. 2. The procedure 400 is for illustration only and other embodiments can be used without departing from the scope of the present disclosure.

As illustrated in FIG. 4, the AP can inform STA during preparation phase about the currently available options. The STA can transmit a request to the current AP about the available options (402). The AP can respond to the STA, e.g., via a management frame, with the option(s) that are currently available (404).

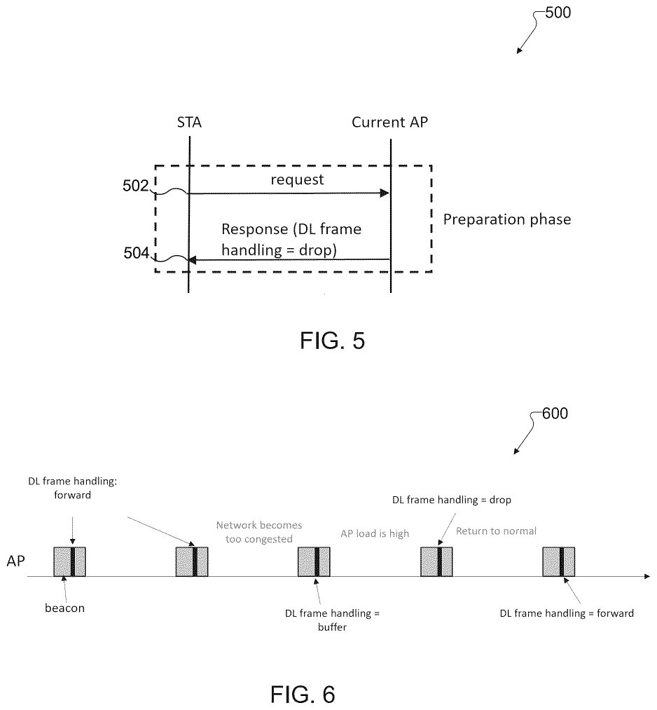

FIG. 5 illustrates an example procedure 500 for an AP side option selection according to embodiments of the present disclosure. For example, the procedure 500 of FIG. 5 can be performed between any of the STAs 111-114 of FIG. 1, such as the AP MLD 111 of FIG. 3 and any of the APs 101-103 of FIG. 1, such as AP MLD 101 of FIG. 2. The procedure 500 is for illustration only and other embodiments can be used without departing from the scope of the present disclosure.

According to one embodiment, the AP can select one option and inform the STA about the selected option. For instance, in response to a request message from the STA (502), the AP can tell the STA how its downlink traffic can be handled via a response message (504). For example, if the network is congested and/or the AP's traffic load is high, the AP may inform the STA that is performing the preparation phase, in 504, that the buffered DL frames of the STA will be dropped as part of the roaming process. According to one embodiment, this can be done on a per-STA basis.

According to another embodiment, this can be done on a BSS level basis. For example, as depicted in FIG. 6, the AP can inform all the STAs in the BSS that their DL frames can be forwarded to another AP (e.g., target AP).

FIG. 6 illustrates an example of advertisement via beacons 600 according to embodiments of the present disclosure. The embodiment of the example of using beacons 600 for advertisement shown in FIG. 6 is for illustration only. Other embodiments could be used without departing from the scope of this disclosure.

In various embodiments, the AP side option selection can be performed at a basic service set (BSS) level. For example, for all STAs in the BSS, the AP advertises its selection of the handling option for DL data frames for any STA in the BSS performing roaming.

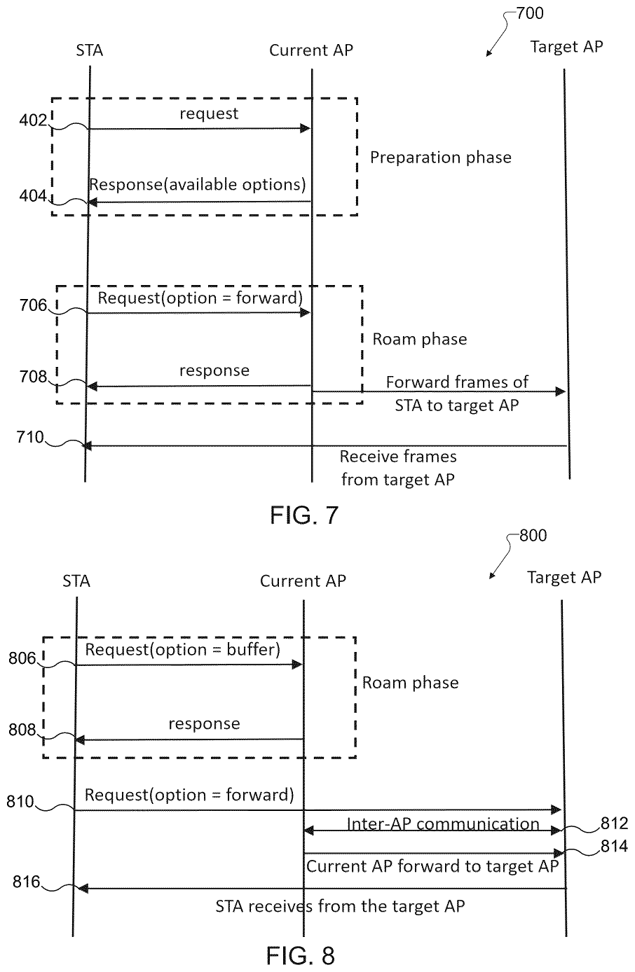

FIG. 7 illustrates an example procedure 700 for a STA side option selection according to embodiments of the present disclosure. For example, the procedure 700 of FIG. 7 can be performed between any of the STAs 111-114 of FIG. 1, such as the AP MLD 111 of FIG. 3 and any of the APs 101-103 of FIG. 1, such as AP MLD 101 of FIG. 2. The procedure 700 is for illustration only and other embodiments can be used without departing from the scope of the present disclosure.

As illustrated in FIG. 7, according to one embodiment, a STA can select an option from the options indicated as available and inform the AP about the selected option. For example, the STA discovers the available options from the current AP during the preparation phase in 404. For example, the STA can also discover the available options via the beacons. The STA then requests the selected option (e.g., to forward the buffered frames to the target AP) (706). The AP responds and forwards the buffered frames to the target AP (708). Thereafter, the STA receives the buffered frames from the target AP (710), e.g., after completion of the roam to the target AP.

In this disclosure, the request message transmitted during the preparation phase (e.g., 402) can be a preparation request frame or a set transition (ST) preparation request frame. In this disclosure, the response message during the preparation phase (e.g., 404) can be a preparation response frame or an ST preparation response frame. In this disclosure, the request message transmitted during the execution phase can be an execution request frame or an ST execution request frame. In this disclosure, the response message during the execution phase can be an execution response frame or an ST execution response frame.

FIG. 8 illustrates an example procedure 800 for STA side option selection with the current AP informed via the target AP according to embodiments of the present disclosure. For example, the procedure 800 of FIG. 8 can be performed between any of the STAs 111-114 of FIG. 1, such as the AP MILD 111 of FIG. 3 and any of the APs 101-103 of FIG. 1, such as AP MLD 101 of FIG. 2. The procedure 800 is for illustration only and other embodiments can be used without departing from the scope of the present disclosure.

As illustrated in FIG. 8, according to one embodiment, the STA can inform/modify its preference through the target AP. This can be useful in situations where the current AP MILD becomes unreachable to the non-AP MLD after transmission of the roam request frame or after completion of the roam phase.

The STA requests the selected option (e.g., to buffer the DL data frames) (806). The AP responds (808) and buffers the DL data frames later transmission to STA. Thereafter, the STA transmits a second request for the current AP to forward the buffered DL data frames to the target AP (810), for example, if the current AP MLD is not reachable. The target AP then informs, via inter AP communication, the current AP to forward the buffered DL data frames to the target AP (812). The current AP to forwards the buffered DL data frames to the target AP (814). The target (now current) AP then sends the received DL data frames to the STA (816).

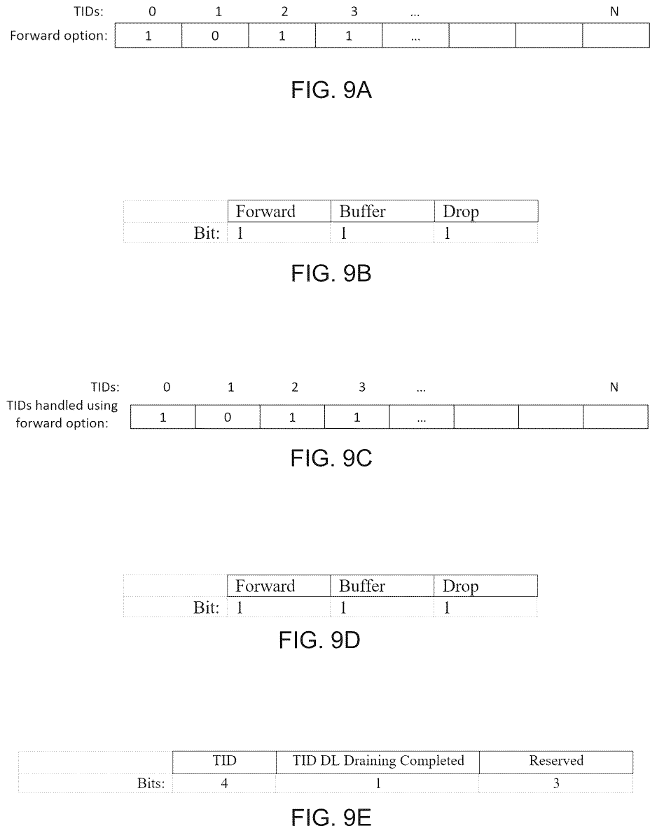

FIGS. 9A-9D illustrate examples of option indications/selections according to embodiments of the present disclosure. The examples illustrated in FIGS. 9A-9D are for illustration only. Other embodiments could be used without departing from the scope of this disclosure.

In various embodiments, only one option can be selected and/or indicated for a particular TID. According to another embodiment, multiple options can be indicated for a TID and the actual option to use can be determined by the AP (or the STA) based on the situation.

FIG. 9A illustrates signaling of options available. According to one embodiment, the option can be enabled a disabled for different TIDs by using a TID bitmap as illustrated in FIG. 9A. For example, there can be a TID bitmap for forward option. A value of 1 in the ith bit position of this TID bitmap can indicate to the non-AP MLD that the forward option can be available for the ith TID. A value of 0 in the ith bit position of this TID bitmap can indicate to the non-AP MLD that the forward option is not available for the ith TID. Similarly, a value of 1 in the bit position 0 can indicate that forward option is not available for TID 0. A value of 0 in the bit position 1 can indicate that forward option is not available for TID 1. In additional embodiments, additional or alternative TID bitmaps can be included for each of the other options, including the buffering and dropping options.

FIG. 9B illustrates an example bitmap for indication of the handling options. According to one embodiment, there can be a single bit that makes the indication. There can be a bit for each option. The bit value can be set to 1 if the option is available and to 0 if the option is not available.

FIG. 9C illustrates an example signaling of options to be used. An indication can be provided by using a TID bitmap. For example, for each option, there can be a TID bitmap that can have a value of 1 for the TIDs whose frames can be handled using that option and a value of 0 for the TIDs whose frames cannot be handled without using that option. As illustrated in FIG. 9C, the example TID bitmap provides an indication of which TIDs to forward. In additional embodiments, additional or alternative TID bitmaps can be included for each of the other options, including the buffering and dropping options.

FIG. 9D illustrates an example of a bit based indication. For example, as illustrated, a forward bit can be set to 1 to indicate that the buffered DL frames after roam phase completion can be forwarded to the target AP MLD, a buffer bit can be set to 1 to indicate that the buffered DL frames can be buffered, and a drop bit can be set to 1 to indicate that the buffered DL frames can be dropped.

Various embodiments also provide examples of how the indication can be conveyed. According to one embodiment, the indications of the preferences on how to handle DL frames can be provided in a link reconfiguration request frame. The modified link reconfiguration request frame can have a format as shown in Table 2. The order can be different than this example. One or more additional information items can be present.

TABLE 2
Example modified link reconfiguration
request frame action field format.

| Order | Meaning |
|---|---|
| 1 | Category |
| 2 | Protected ultra-high reliability (UHR)/extremely |
| | high throughput (EHT) Action |
| 3 | Dialog token |
| 4 | DL frame handling indication |
| 5 | Reconfiguration Multi-link element |
| 6 | OCI element |

According to one embodiment, the indication can be provided during the roaming or execution phase. According to another embodiment, the indication can be provided during the preparation phase.

Various embodiments provide for a capability advertisement. According to one embodiment, an AP that can handle DL frames after roaming phase completion can provide an indication of the capability to do so. The indication can be provided via a field (e.g., a bit) that can take a predetermined value (e.g., 1) to make an indication of the support and to another value (e.g., 0) to indicate otherwise. The advertisement can be provided in management frames such as beacons, probe responses, (re)association responses, etc. The indication bit can be present inside an element, e.g., in UHR operation element.

According to one embodiment, a STA that can handle DL frames after roaming phase completion can provide an indication of the capability to do so. This can require the STA to have the capability to fetch DL frames from the previous AP MLD. The indication can be provided via a field (e.g., a bit) that can take a predetermined value (e.g., 1) to make the indication and to another predetermined value (e.g., 0) to indicate otherwise. The indication can be provided in management frames such as probe requests, (re)association requests, etc. The indication can be carried inside an element, e.g., UHR capabilities element. The indication of the STA's capability can also be made implicitly, e.g., a STA that supports enhanced multi-link single radio (EMLSR)/simultaneous transmit and receive (STR) operation can support such a capability to handle DL frames after roaming phase completion.

Various embodiments provide for a buffer size/status indication. According to one embodiment, the current AP MLD can provide the status of downlink transmission buffers of the current AP MLD to the non-AP MLD. According to one embodiment, the status of downlink transmission buffers can be provided per TID or access class (AC). The indication can be provided upon request or in an unsolicited manner.

According to another embodiment, the current AP MLD can provide the status of the downlink transmission buffers by transmitting a buffer status report (BSR) to the non-AP MLD. The BSR can be sent on different links to report the buffer status on different links.

According to another embodiment, a new type of container can be defined to carry the information. According to one embodiment, this can be a new A-control field or a new management frame.

According to one embodiment, the current AP MLD can provide the status of the downlink transmission buffers in the link reconfiguration response frame that is transmitted as an execution response frame. This can also be provided during the preparation phase.

The indication can also be provided in a UHR link reconfiguration notify frame. The UHR link reconfiguration notify frame can contain a per-TID info field which can have a format as shown in FIG. 9E, which illustrates an example format of a per-TID info field on the indication of the status of the downlink transmission buffers. The example illustrated in FIG. 9E is for illustration only. Other embodiments could be used without departing from the scope of this disclosure.

As illustrated in FIG. 9E, the TID field can be set to the TID for which the indication can be provided. The TID DL draining completed can be set to 1 if there are no more buffered DL traffic for the TID specified in the TID field. The field can be set to 0 otherwise.

The status of downlink transmission buffers can be provided on a per-link basis or can be provided on a MLD level. The information of downlink transmission buffers can be useful also to determine how long the retrieval of data on the downlink can take.

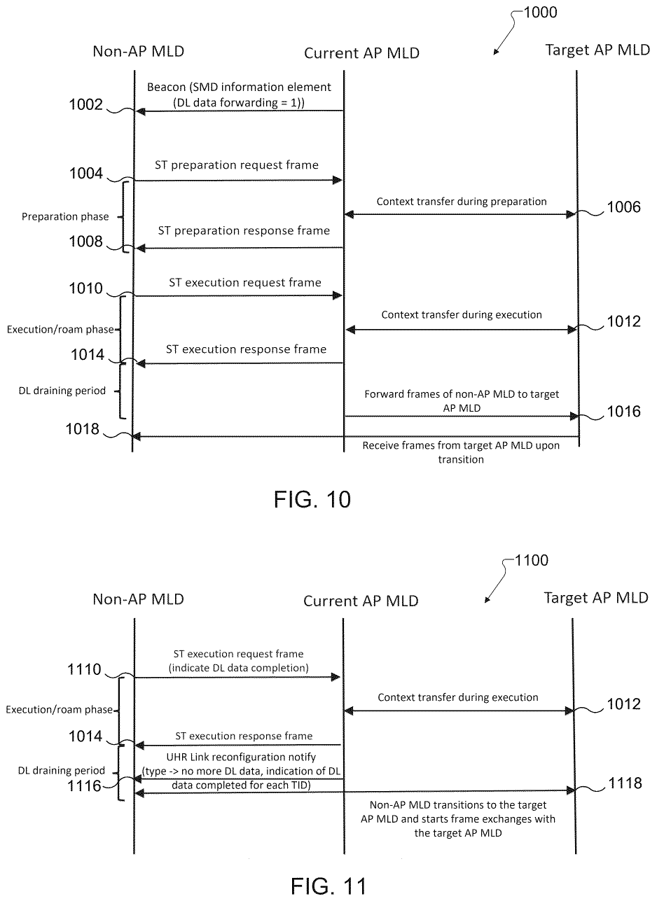

FIG. 10 illustrates an example procedure 1000 for advertisement and handling of buffered DL data frames of an non-AP MLD for a roam from a current AP MLD to a target AP MLD according to embodiments of the present disclosure. For example, the procedure 1000 of FIG. 10 can be performed between any of the STAs 111-114 of FIG. 1, such as the AP MLD 111 of FIG. 3 and any of the APs 101-103 of FIG. 1, such as AP MLD 101 of FIG. 2. The procedure 1000 is for illustration only and other embodiments can be used without departing from the scope of the present disclosure.

As illustrated in FIG. 10, during initial association or in a probe response, in a beacon, the current AP MLD can indicate to the non-AP MLD that the DL data forwarding is supported (1002). The non-AP MLD sends the current AP MLD a ST preparation request frame (1004) for the preparation phase of the roam. The current and target AP MLDs exchange context during the preparation phase (1006) and the current AP MLD sends the non-AP MLD the ST preparation response frame (1008). The non-AP MLD sends the current AP MLD a ST execution request frame (1010) for the execution phase of the roam. The current and target AP MLDs exchange context during the execution phase (1012) and the current AP MLD sends the non-AP MLD the ST execution response frame (1014).

The current AP MLD can continue to transmit DL data frames to the non-AP MLD for a period of time referred to as DL draining period starting after the reception of the acknowledgement of the ST execution response (1014), and terminating after a nominal duration indicated by the nominal maximum DL draining period duration field carried in the ST execution response (1014). If downlink data forwarding is supported, the current AP MLD can forward the downlink data for the non-AP MLD to the target AP MLD (1016) during the DL draining period.

The forwarding can occur at the start of the DL draining period. For instance, if the current AP MLD has determined which data frames it cannot forward to the non-AP MLD the current AP MLD can forward them to the target AP MLD at the start of the DL draining period.

The forwarding can occur during the DL draining period. For instance, if the current AP MLD has determined during the DL draining period that it cannot forward all the frame to the non-AP MLD based on one or more factors such as the left over time of the DL draining period, for example, a drop in a received signal strength indicator (RSSI) causing the drop in the data rate of the frame used which can increase air time consumption of transmissions to the non-AP MLD, sudden loss of link(s) with the non-AP MLD, etc.

The forwarding can occur at the end of the DL draining period. For instance, if the current AP MLD has not been able to transmit all the buffered frames of the non-AP MLD during the DL draining period and the DL draining period ends, the current AP MLD can forward the frames to the target AP MLD (1016).

If the DL data forwarding support has been advertised to the non-AP MLD, the non-AP MLD can expect to receive the frames from the target AP MLD and receives the forwarded frames (1018). If the DL data forwarding has been advertised as not supported, i.e., the bit in SMD information element has been set to 0, then the current AP MLD cannot forward frames of the non-AP MLD to the target AP MLD

FIG. 11 illustrates an example procedure 1100 handling of buffered DL data frames of an non-AP MLD for a roam from a current AP MLD to a target AP MLD according to embodiments of the present disclosure. For example, the procedure 1100 of FIG. 11 can be performed between any of the STAs 111-114 of FIG. 1, such as the AP MLD 111 of FIG. 3 and any of the APs 101-103 of FIG. 1, such as AP MLD 101 of FIG. 2. The procedure 1100 is for illustration only and other embodiments can be used without departing from the scope of the present disclosure.

As illustrated in FIG. 11, non-AP MLD can request to the current AP MLD to indicate DL data completion for a subset of TIDs in the ST execution request frame 1110. The current AP MLD can transmit a UHR link reconfiguration notify frame to the non-AP MLD 1116 with type field set to a value to provide an indication of no more DL data and an indication of DL data completed for each TID that has a block acknowledgement agreement.

When the non-AP MLD receives this indication from the current AP MLD, the non-AP MLD and the current AP MLD can delete their links and the non-AP MLD can transition to the target AP MLD and start performing frame exchanges with the target AP MLD (1118).

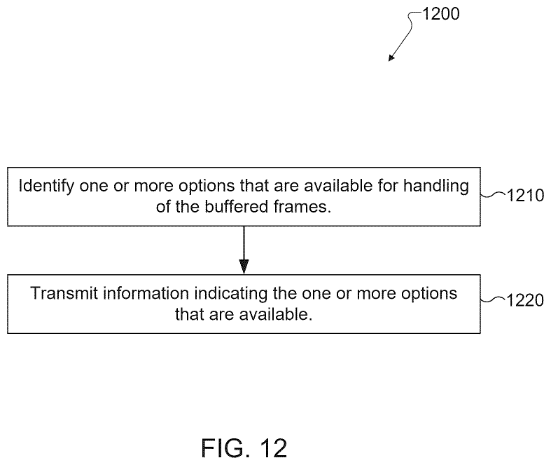

FIG. 12 illustrates an example method 1200 performed by an AP MLD in a wireless communication system according to embodiments of the present disclosure. The method 1200 of FIG. 12 can be performed by any of the APs 101-103 of FIG. 1, such as the AP MLD 101 of FIG. 2A, and a corresponding method can be performed by any of the STAs 111-116 of FIG. 1, such as non-AP MLD 111 of FIG. 2B. The method 1200 is for illustration only and other embodiments can be used without departing from the scope of the present disclosure.

The method 1200 begins with the current AP MLD identifying one or more of the options that are available for handling of the buffered frames (1210). For example, in 1210, the options are identified from a plurality of options for handling of buffered frames at the current AP MLD. Additionally, these options are handling of the buffered frames of the non-AP MLD for the non-AP MLD to roam from the current AP MLD to a target AP MLD. For example, the plurality of options for handling of the buffered frames include an operation for the current AP MLD to forward the buffered frames for the non-AP MLD to the target AP MLD, an operation for the current AP MLD to drop the buffered frames for the non-AP MLD, and an operation for the current AP MILD to transmit the buffered frames to the non-AP MLD. Additionally, which of the plurality of options are available to include in the one or more options indicated in the management frame is based on network conditions.

The current AP MLD then transmits information indicating the one or more options that are available (1220). For example, in 1220, the AP MLD may transmit the information to the non-AP MLD via a management frame, such as for example, a beacon frame, probe response frame, or reassociation response frame. In various embodiments, the information indicating the one or more options that are available includes a TID bitmap indicating one or more options for a plurality of TIDs corresponding to the buffered frames. In various embodiments, the current AP MLD transmits, to the non-AP MILD, information indicating a buffer status for a plurality of TIDs corresponding to the buffered frames.

In various embodiments, the current AP MLD selects an option for handling of the buffered frames and handles the buffered frames according to the selected option. In these embodiments, the current AP MLD transmits the information indicating the one or more options that are available as information indicating the selected option.

In various embodiments, the current AP MLD receives, from the non-AP MLD, information indicating a selection of an option from the one or more options for handling of one or more of the buffered frames and determines, based on the selection, how to handle the one or more buffered frames for the roam of the non-AP MLD from the current AP MLD to the target AP MLD. In some examples, the information indicating the selection of the option from the one or more options is received from the non-AP MLD via the target AP MLD and the current AP MLD determines to forward the one or more buffered frames to the target AP MLD or to drop the one or more buffered frames.

In various embodiments, the information indicating the one or more options that are available includes a DL data forwarding field set to 1 to indicate that forwarding of buffered DL data of the non-AP MLD from the current AP MLD to the target AP MLD is supported. The current AP MLD then forwards, based on forwarding of DL buffered data being supported, one or more of the buffered frames for the non-AP MLD to the target AP MLD during a DL draining period.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a current access point (AP) multi-link device (MLD), the method comprising:
identifying, from a plurality of options for handling of buffered frames at the current AP MLD for a non-AP MLD to roam from the current AP MLD to a target AP MLD, one or more of the options that are available for handling of the buffered frames; and
transmitting, to the non-AP MLD via a management frame, information indicating the one or more options that are available.

2. The method of claim 1, wherein:
the plurality of options for handling of the buffered frames include:
an operation for the current AP MLD to forward the buffered frames for the non-AP MLD to the target AP MLD,
an operation for the current AP MLD to drop the buffered frames for the non-AP MLD, and
an operation for the current AP MLD to transmit the buffered frames to the non-AP MLD; and
which of the plurality of options are available to include in the one or more options indicated in the management frame is based on network conditions.

3. The method of claim 1, further comprising:
selecting an option for handling of the buffered frames; and
handling the buffered frames according to the selected option,
wherein transmitting the information indicating the one or more options that are available further comprises transmitting the information indicating the selected option.

4. The method of claim 1, further comprising:
receiving, from the non-AP MLD, information indicating a selection of an option from the one or more options for handling of one or more of the buffered frames; and
determining, based on the selection, how to handle the one or more buffered frames for the roam of the non-AP MLD from the current AP MLD to the target AP MLD.

5. The method of claim 4, wherein:
the information indicating the selection of the option from the one or more options is received from the non-AP MLD via the target AP MLD, and
determining how to handle the one or more buffered frames further comprises determining to forward the one or more buffered frames to the target AP MLD or to drop the one or more buffered frames.

6. The method of claim 1, wherein the information indicating the one or more options that are available includes a transmit identifier (TID) bitmap indicating one or more options for a plurality of TIDs corresponding to the buffered frames.

7. The method of claim 1, further comprising transmitting, to the non-AP MLD, information indicating a buffer status for a plurality of transmit identifiers (TIDs) corresponding to the buffered frames.

8. The method of claim 1, wherein:
the information indicating the one or more options that are available includes a downlink (DL) data forwarding field set to 1 to indicate that forwarding of buffered DL data of the non-AP MLD from the current AP MLD to the target AP MLD is supported, and
the method further comprises forwarding, based on forwarding of DL buffered data being supported, one or more of the buffered frames for the non-AP MLD to the target AP MLD during a DL draining period.

9. A method performed by a non-access point (AP) multi-link device (MILD), the method comprising:
receiving, from a current AP MLD via a management frame, information indicating one or more options that are available, from a plurality of options for handling of buffered frames at the current AP MLD, for handling of the buffered frames of the non-AP MLD; and
determining, based on the received information, an option for handling of the buffered frames for the non-AP MLD to roam from the current AP MLD to a target AP MLD.

10. The method of claim 9, wherein:
the plurality of options for handling of the buffered frames include:
an operation for the current AP MLD to forward the buffered frames for the non-AP MLD to the target AP MLD,
an operation for the current AP MLD to drop the buffered frames for the non-AP MLD, and
an operation for the current AP MLD to transmit the buffered frames to the non-AP MLD; and
which of the plurality of options are available to include in the one or more options indicated in the management frame is based on network conditions.

11. The method of claim 9, wherein receiving the information indicating the one or more options that are available further comprises transmitting the information indicating the option that was selected by the current AP MLD.

12. The method of claim 9, further comprising transmitting information indicating a selection of the option from the one or more options for handling of one or more of the buffered frames at the current AP MILD.

13. The method of claim 12, wherein the information indicating the selection of the option from the one or more options is transmitted to the target AP MLD.

14. The method of claim 9, wherein the information indicating the one or more options that are available includes a transmit identifier (TID) bitmap indicating one or more options for a plurality of TIDs corresponding to the buffered frames.

15. The method of claim 9, further comprising receiving, from the current AP MLD, information indicating a buffer status for a plurality of transmit identifiers (TIDs) corresponding to the buffered frames.

16. The method of claim 9, wherein:
the information indicating the one or more options that are available includes a downlink (DL) data forwarding field set to 1 to indicate that forwarding of buffered DL data of the non-AP MLD from the current AP MLD to the target AP MLD is supported, and
based on forwarding of DL buffered data being supported, one or more of the buffered frames for the non-AP MLD are forwarded to the target AP MLD during a DL draining period.

17. An electronic device comprising:
at least one processor including processing circuitry; and
memory storing instructions, wherein the instructions, when executed by the at least one processor individually or collectively, cause the electronic device to:
identify, from a plurality of options for handling of buffered frames at a current access point (AP) multi-link device (MLD) for a non-AP MLD to roam from the current AP MLD to a target AP MLD, one or more of the options that are available for handling of the buffered frames; and
transmit, to the non-AP MLD via a management frame, information indicating the one or more options that are available.

18. The electronic device of claim 17, wherein the instructions, when executed by the at least one processor individually or collectively, cause the electronic device to:
select an option for handling of the buffered frames; and
handle the buffered frames according to the selected option, wherein the transmitted information indicates the selected option.

19. The electronic device of claim 17, wherein the instructions, when executed by the at least one processor individually or collectively, cause the electronic device to:
receive, from the non-AP MLD, information indicating a selection of an option from the one or more options for handling of one or more of the buffered frames; and
determine, based on the selection, how to handle the one or more buffered frames for the roam of the non-AP MLD from the current AP MLD to the target AP MLD.

20. The electronic device of claim 17, wherein:
the information indicating the one or more options that are available includes a downlink (DL) data forwarding field set to 1 to indicate that forwarding of buffered DL data of the non-AP MLD from the current AP MLD to the target AP MLD is supported, and
the instructions, when executed by the at least one processor individually or collectively, cause the electronic device to forward, based on forwarding of DL buffered data being supported, one or more of the buffered frames for the non-AP MLD to the target AP MLD during a DL draining period.
